(19) United States
(12) Patent Application Publication
(10) Pub. No.: US 2025/0275838 A1
(43) Pub. Date: Sep. 4, 2025

(54) DENTAL CROWN MODEL GENERATION METHOD AND DENTAL CROWN MODEL GENERATION SYSTEM

(71) Applicant: Dentscape CO., LTD., Taipei City (TW)

(72) Inventors: Cheng-Kang Chou, Taipei City (TW); Hsiao-Yang Liu, Taipei City (TW); Yi-Chen Chen, Taipei City (TW); Da-Rong Liu, Taipei City (TW)

(21) Appl. No.: 19/064,732

(22) Filed: Feb. 27, 2025

Related U.S. Application Data
(60) Provisional application No. 63/559,892, filed on Mar. 1, 2024.

(51) Int. Cl. A61C 13/00; B33Y 50/00; B33Y 80/00; G06T 7/00; G06T 7/73; G06T 17/00; G06T 19/20; G06V 10/766; G06V 20/64

(52) U.S. Cl. CPC A61C 13/0004; A61C 13/0019; B33Y 50/00; B33Y 80/00; G06T 7/0012; G06T 7/75; G06T 17/00; G06T 19/20; G06V 10/766; G06V 20/64; G06T 2200/04; G06T 2207/20036; G06T 2207/30036; G06T 2210/41; G06T 2219/2016; G06V 2201/03

(57) ABSTRACT

The present invention provides a dental crown model generation method and a dental crown model generation system. The method includes: retrieving preset dental shape data including multiple geometric features based on the target position of the treated tooth; adjusting the preset dental shape using rotation, stretching, and translation parameters to obtain the adjusted geometric features; scoring the matching degree between the adjusted geometric feature and multiple conditional operations; performing weighted calculations on the scores to obtain a denture score; if the denture score is below a threshold score, inputting the denture score into a parameter correction artificial intelligence unit to obtain new rotation, stretching, and translation parameters, and continuing the adjustment until the denture score exceeds the threshold score; and using the dental shape corresponding to the final parameters as the final dental crown model for the patient.

### CROSS-REFERENCE TO RELATED APPLICATION

The present disclosure claims the benefit of and priority to U.S. provisional Patent Application Ser. No. 63/559,892 filed on Mar. 1, 2024, entitled “APPARATUSES AND METHODS FOR TWO-DIMENSIONAL AND THREE-DIMENSIONAL DENTAL DESIGN USING DENTAL IMAGE DATA,” (hereinafter referred to as “the '892 provisional”). The disclosure of the '892 provisional is hereby incorporated fully by reference into the present disclosure.

### FIELD

The present invention relates to a dental crown model generation technology, and more specifically, to an automatic dental crown model generation method utilizing artificial intelligence technology and a dental crown model generation system using the method.

### BACKGROUND

In prior art, when a dentist needs to perform dental treatment on a patient, if the condition of the tooth is found to be poor, the patient may require root canal treatment. After these treatments are completed, the next step usually involves a dental crown fabrication process. Traditionally, the dental crown fabrication is a complex and tedious process, which typically requires the dentist to take an impression of the patient's tooth and fabricate the crown based on the mold.

First, the dentist conducts a detailed oral examination of the patient's missing tooth area, then uses professional materials to take an impression of the missing tooth portion. This mold is used to create the dental crown model. However, during this process, the patient often needs to wear temporary crowns for an extended period. These temporary crowns are typically handcrafted by the dentist personally, requiring significant time and effort, as the dentist must make individual adjustments and meticulous carvings based on the specific conditions of the patient's oral cavity.

After completing the impression, the dentist sends the model to an external dental laboratory, where a dental technician casts the dental crown model. This process also takes time, and in some cases, the dentist may need to perform additional fine carvings and adjustments based on the model's outcome to ensure that the crown's size, shape, and functionality fully meet the patient's oral structure requirements. This not only tests the technology but also places high demands on the patience and craftsmanship of the dental technician. Meanwhile, during the dental technician's fabrication of the crown, the patient must wear a temporary denture.

Additionally, although dental crown fabrication technology is relatively mature, traditional manual fabrication and adjustment processes still have certain limitations, such as human errors during production, high time costs, and various inconveniences for patients during the waiting period. These factors make the dental crown fabrication process both cumbersome and challenging, requiring patients to make multiple follow-up visits, thereby increasing the complexity of the entire treatment process. Therefore, traditional dental crown fabrication methods are not only time-consuming but also demand high professional skills from dental technicians, requiring multiple rounds of communication and collaboration with external manufacturers, making the entire process extremely tedious and inefficient.

### SUMMARY

One objective of a preferred embodiment of the present invention is to provide a dental crown model generation method and system, which can automatically generate a dental crown model after scanning a patient's teeth model.

Another objective of a preferred embodiment of the present invention is to provide a dental crown model generation method and system, which can generate a temporary dental crown during dental treatment.

In view of the above, a preferred embodiment of the present invention provides a dental crown model generation method, which includes: providing a plurality of geometric features based on a three-dimensional dental image model; retrieving data of a preset teeth model based on a target position of a tooth to be treated; step A: adjusting the preset teeth model by using a plurality of dental model parameters to generate a test tooth model, thereby obtaining a plurality of preset geometric features; step B: generating a plurality of conditional operations based on a tooth shape curve and the plurality of geometric features; step C: scoring a matching degree between the plurality of preset geometric features and the plurality of conditional operations to obtain a plurality of scores; step D: performing weighted calculations on the plurality of scores using a plurality of weights to obtain a denture score; if the denture score is below a threshold score, inputting the denture score into a parameter correction artificial intelligence unit to update the plurality of dental model parameters and repeating step A to step D until the denture score exceeds the threshold score; and using the test tooth model corresponding to the updated plurality of dental model parameters as a final dental crown model.

Another preferred embodiment of the present invention provides a dental crown model generation system, which includes a three-dimensional (3D) image input device, a conditional operation generation module, an artificial intelligence denture analysis model, a parameter correction artificial intelligence unit, a judgment module, and a model generation unit. The 3D image input device is configured to scan a patient's teeth to obtain a three-dimensional (3D) dental image model, retrieve data of a preset teeth model based on a target position of a tooth to be treated, and provide a plurality of geometric features according to the 3D dental image model. The conditional operation generation module is configured to obtain a plurality of conditional operations based on a tooth shape curve and the plurality of geometric features.

The artificial intelligence denture analysis model is configured to execute: step A: adjust the preset teeth model by using a plurality of dental model parameters to generate a test tooth model, thereby obtaining a plurality of preset geometric features; step B: generate a plurality of conditional operations using the plurality of geometric features; step C: score a matching degree between the plurality of preset geometric features and the plurality of conditional operations to obtain a plurality of scores; and step D: perform weighted calculations on the plurality of scores using a plurality of weights to obtain a denture score. The parameter correction artificial intelligence unit is configured to update the plurality of dental model parameters based on the denture score and feed the updated plurality of dental model parameters back to the artificial intelligence denture analysis model. The judgment module is configured to compare the denture score with a threshold score. When the denture score is below the threshold score, it outputs the denture score to the parameter correction artificial intelligence unit. The model generation unit is coupled to the judgment module. When the denture score exceeds the threshold score, it generates a final dental crown model based on the test tooth model corresponding to the updated plurality of dental parameters.

The preferred embodiment of the present invention provides a dental crown model generation method. The invention utilizes regression analysis and artificial intelligence to automatically adjust parameters, significantly reducing production time and minimizing human operational errors and instability. Secondly, the present invention performs precise calculations and automatic optimization based on the patient's 3D imaging data and tooth shape curves, thus eliminating the need for manual carving or repeated adjustments, ensuring the accuracy of the dental crown model and meeting the individual needs of the patient. Finally, through the weighted calculations and AI-based corrections, the optimal dental crown model can be automatically achieved, thus avoiding oversights in manual operations and improving treatment outcomes and patient comfort.

In order to make the above and other objectives, features, and advantages of the present invention more apparent and easier to understand, preferred embodiments are described in detail below with reference to the accompanying drawings.

### BRIEF DESCRIPTION OF THE DRAWINGS

The provided drawings are intended to enable those ordinarily skilled in the art to which the present invention belongs to further understand the present invention and are incorporated as part of the specification of the present invention. The drawings illustrate exemplary embodiments of the present invention and are used together with the specification to describe the principles of the present invention.

FIG. 1 shows a system block diagram of a dental crown model generation system according to a preferred embodiment of the present invention.

FIG. 2A shows a schematic diagram of a preset upper jaw dental model provided by the dental crown model generation system according to a preferred embodiment of the present invention.

FIG. 2B shows a schematic diagram of a preset lower jaw dental model provided by the dental crown model generation system according to a preferred embodiment of the present invention.

FIG. 3 shows a schematic diagram of a 3D dental image model scanned by a 3D image input device 101 of the dental crown model generation system according to a preferred embodiment of the present invention.

FIG. 4 shows a schematic diagram of a preset tooth model 11 retrieved from the 3D dental image model shown in FIG. 3 by the dental crown model generation system according to a preferred embodiment of the present invention.

FIG. 5 shows a schematic diagram of a patient's dental crown model generated in conjunction with a 3D dental image model scanned by a 3D image input device 101 of the dental crown model generation system according to a preferred embodiment of the present invention.

FIG. 6 shows a schematic diagram of a 3D dental image model scanned by a 3D image input device 101 of the dental crown model generation system according to a preferred embodiment of the present invention.

FIG. 7 shows a schematic diagram of a preset tooth model 46 retrieved from the 3D dental image model shown in FIG. 6 by the dental crown model generation system according to a preferred embodiment of the present invention.

FIG. 8 shows a schematic diagram of a top-view regression curve calculated by a conditional operation generation module 103 of the dental crown model generation system based on buccal cusp feature points of adjacent teeth according to a preferred embodiment of the present invention.

FIG. 9 shows a schematic diagram of a top-view regression curve calculated by a conditional operation generation module 103 of the dental crown model generation system based on lingual cusp feature points of adjacent teeth according to a preferred embodiment of the present invention.

FIG. 10 shows a schematic diagram of a top-view regression curve calculated by a conditional operation generation module 103 of the dental crown model generation system based on groove feature points of adjacent teeth according to a preferred embodiment of the present invention.

FIG. 11 shows a schematic diagram of an outer side-view regression curve calculated by a conditional operation generation module 103 of the dental crown model generation system based on buccal cusp feature points of adjacent teeth according to a preferred embodiment of the present invention.

FIG. 12 shows a schematic diagram of an inner side-view regression curve calculated by a conditional operation generation module 103 of the dental crown model generation system based on lingual cusp feature points of adjacent teeth according to a preferred embodiment of the present invention.

FIG. 13 shows a schematic diagram of an inner side-view regression curve calculated by a conditional operation generation module 103 of the dental crown model generation system based on groove feature points of adjacent teeth according to a preferred embodiment of the present invention.

FIG. 14 shows a schematic diagram of a vector dot product calculated by a conditional operation generation module 103 of the dental crown model generation system based on conditions of an abutment tooth according to a preferred embodiment of the present invention.

FIG. 15 shows a schematic diagram of a vector dot product calculated by a conditional operation generation module 103 of the dental crown model generation system based on conditions of a dental crown position and adjacent teeth according to a preferred embodiment of the present invention.

FIG. 16 shows a schematic diagram of an operation condition calculated by a conditional operation generation module 103 of the dental crown model generation system based on conditions of a dental crown model according to a preferred embodiment of the present invention.

FIG. 17 to FIG. 20 respectively show schematic diagrams of a patient's dental crown model generated by the dental crown model generation system according to a preferred embodiment of the present invention.

FIG. 21 shows a flowchart of a dental crown model generation method according to a preferred embodiment of the present invention.

### DETAILED DESCRIPTION

Exemplary embodiments of the present invention will be described in detail below, and these embodiments are illustrated in the accompanying drawings. Wherever possible, the same reference numerals are used in the drawings and description to refer to the same or similar elements. Furthermore, the exemplary embodiments are merely some of the implementations of the design concept of the present invention, and the following examples are not intended to limit the scope of the present invention.

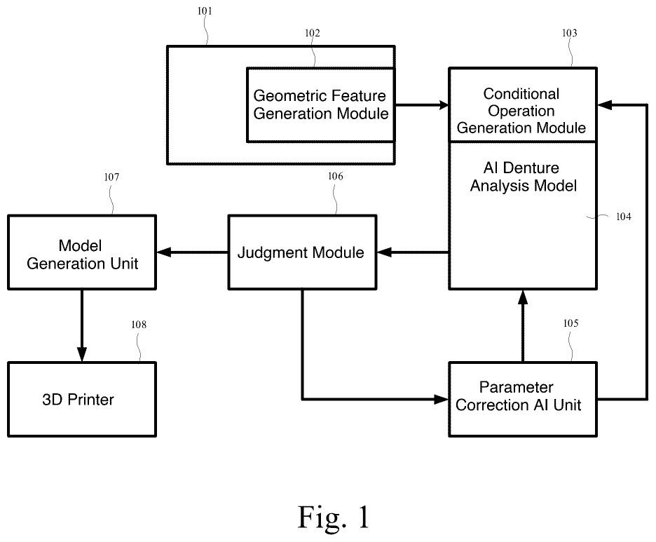

FIG. 1 shows a system block diagram of a dental crown model generation system according to a preferred embodiment of the present invention. Referring to FIG. 1, in the present embodiment, a dental crown model generation system includes a three-dimensional (3D) image input device 101, a conditional operation generation module 103, an artificial intelligence (AI) denture analysis model 104, a parameter correction artificial intelligence (AI) unit 105, a judgment module 106, a model generation unit 107, and a three-dimensional (3D) printer 108. In the present embodiment, the 3D image input device 101 includes a geometric feature generation module 102, which includes an image recognition artificial intelligence (AI) model. In addition, the AI denture analysis model 104 may include a conditional operation generation module 103.

Specifically, when a dentist determines that a patient requires denture installation treatment typically after completing root canal treatment, tooth extraction treatment, or dental implant treatment, the dentist can use the 3D image input device 101 to scan the patient's teeth to obtain a 3D dental image model. The 3D dental image model includes a target position of a tooth to be treated.

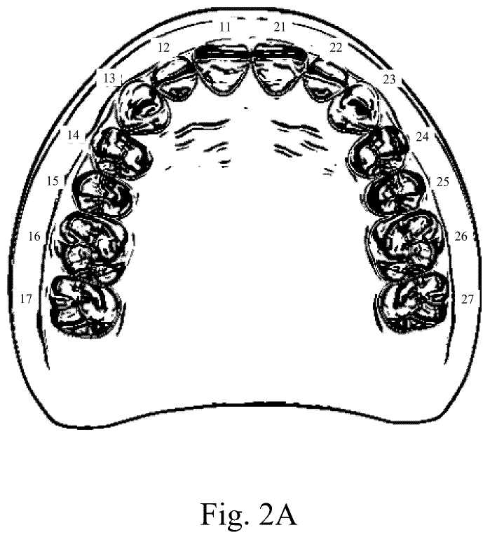

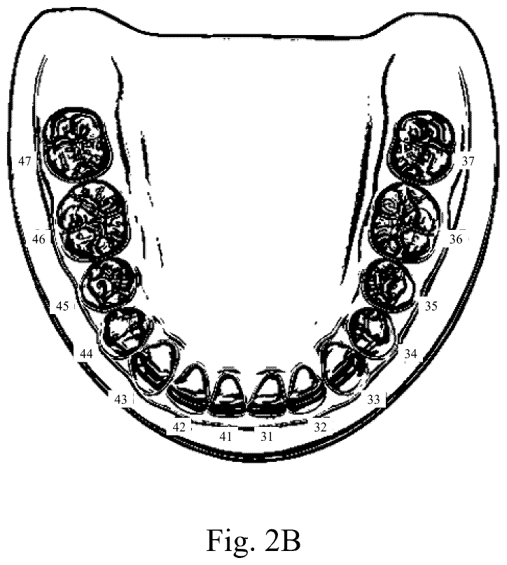

FIG. 2A shows a schematic diagram of a preset upper jaw dental model provided by the dental crown model generation system according to a preferred embodiment of the present invention. FIG. 2B shows a schematic diagram of a preset lower jaw dental model provided by the dental crown model generation system according to a preferred embodiment of the present invention. Referring to FIG. 2A and FIG. 2B, in the present embodiment, the seven right-side teeth of the upper jaw are labeled as 11 to 17; the seven left-side teeth of the upper jaw are labeled as 21 to 27; the seven right-side teeth of the lower jaw are labeled as 41 to 47; and the seven left-side teeth of the upper jaw are labeled as 31 to 37. The preset teeth models 11-17, 21-27, 41-47, and 31-37 are based on the Dental Demonstration Teeth Model commonly used by dentists as the initial model. The above tooth numbering follows the tooth numbering system of FDI World Dental Federation.

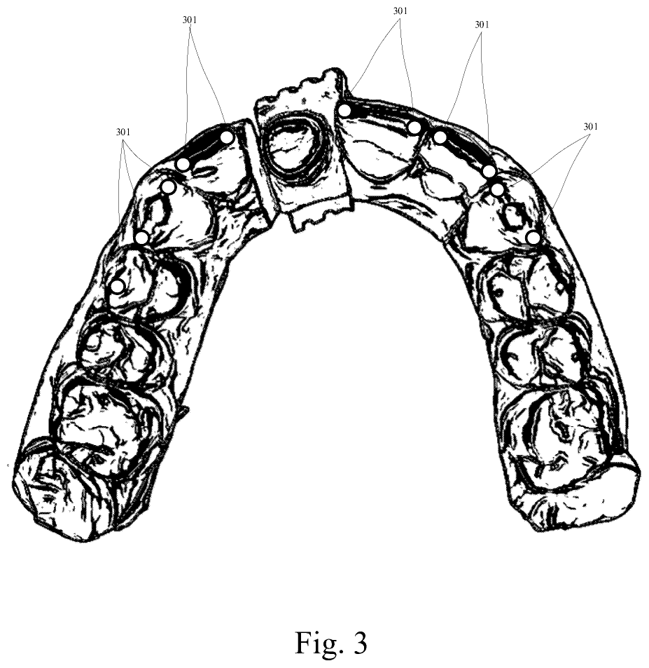

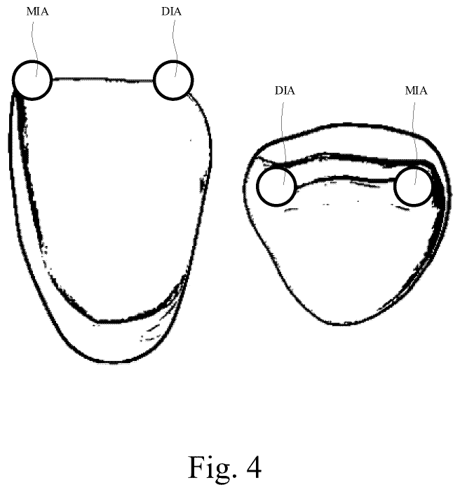

FIG. 3 shows a schematic diagram of a 3D dental image model scanned by a 3D image input device 101 of the dental crown model generation system according to a preferred embodiment of the present invention. Referring to FIG. 3, it is assumed that the patient's 3D dental image model is missing the tooth numbered with 11. At this time, an image recognition AI model within the geometric feature generation module 102 is used to locate a target position 11 of a tooth to be treated from the 3D dental image model and retrieve data of the preset tooth model of the tooth numbered with 11. FIG. 4 shows a schematic diagram of a preset tooth model 11 retrieved from the 3D dental image model shown in FIG. 3 by the dental crown model generation system according to a preferred embodiment of the present invention. Referring to FIG. 4, the left side shows a side view of the preset tooth model 11 while the right side shows a top view of the preset tooth model 11. Labels MIA and DIA represent the feature points of the preset tooth model 11. Since this position presents an incisor, there are only two feature points, that is, a mesiolabioincisal angle and a distolabioincisal angle in the present embodiment.

Referring back to FIG. 3, the geometric feature generation module 102 provides multiple geometric features based on the 3D dental image model. In the present embodiment, feature coordinates 301 are used as an example, but in actual implementation, similar edge lines or other geometric features may also be used. Therefore, the present invention is not limited thereto. These feature coordinates 301 can be automatically identified by the image recognition AI model. In the present embodiment, since FIG. 3 presents a top view, the feature coordinates 301 are, for example, based on the occlusal protruding portions of the tooth. Based on clinical data and experience, these feature coordinates 301 tend to be arranged in a near-parabolic pattern. Therefore, in the present embodiment, the conditional operation generation module 103 is an automated analysis model formed through training and parameter adjustments based on multiple clinical dental experiences. The conditional operation generation module 103 perform operations (e.g., regression analysis) based on the feature coordinates 301 of FIG. 3, the preset feature points MIA and DIA of the preset tooth model 11 at initial positions, and a tooth shape curve, which in the present embodiment is a parabola. By performing the operations (e.g., regression analysis operation), the conditional operation generation module 103 can determine a parabolic regression equation that most closely matches the above feature coordinates.

Once the parabolic regression equation is determined, the AI denture analysis model 104 begins operation. A corresponding plurality of dental model parameters, such as rotation parameters, stretching parameters, translation parameters, etc., in initial preset teeth model data are inputted into the AI denture analysis model 104. The AI denture analysis model 104 scores a matching degree, based on the inputted rotation parameters, stretching parameters, translation parameters, and other critical dental parameters, between a generated model and the parabolic regression equation to obtain multiple scores. In the above embodiment, although only the top view is used to identify a corresponding parabolic regression equation, practical applications may also include corresponding regression equations generated from feature coordinates on outer side-views and inner side-views. The illustrative example simplifies the above description.

After the multiple scores are obtained, all scores are weighted and summed to obtain a denture score. The denture score is then transmitted to the judgment module 106. The judgment module 106 can compare the denture score with a threshold score. When the denture score is below the threshold score, it outputs the denture score to the parameter correction AI unit 105. The parameter correction AI unit 105 adjusts and updates the plurality of dental model parameters based on the inputted denture score, feeds the updated dental model parameters back to the artificial intelligence denture analysis model. The conditional operation generation module 103 then identifies another dental crown position based on the dental moldel parameters and generates another parabolic regression equation based on the newly generated preset feature points. Through the iterative operation of the conditional operation generation module 103, the AI denture analysis model 104, the judgment module 106, and the parameter correction AI unit 105, the process continues until the denture score exceeds the threshold score. The judgment module 106 then transmits a final plurality of dental model parameters to the model generation unit 107. The model generation unit 107 generates a patient's dental crown model based on a test tooth model corresponding to the plurality of dental model parameters.

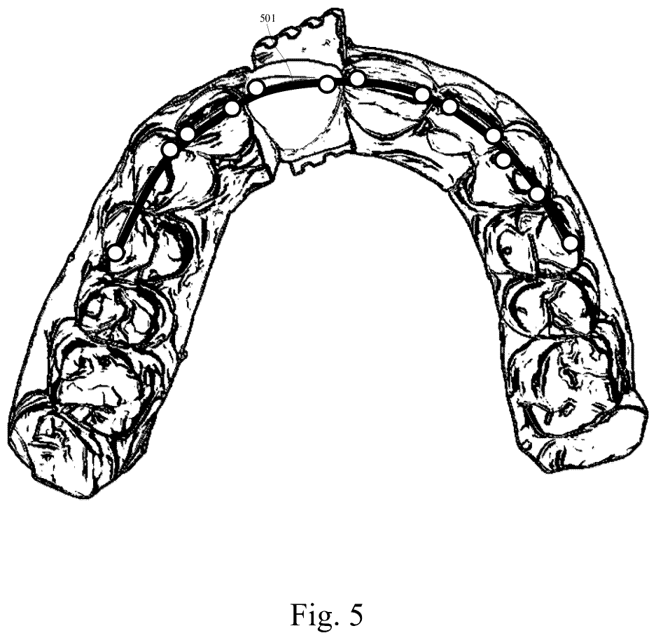

FIG. 5 shows a schematic diagram of a patient's dental crown model generated in conjunction with a 3D dental image model scanned by a 3D image input device 101 of the dental crown model generation system according to a preferred embodiment of the present invention. Referring to FIG. 5, from the tooth model at position 11, it can be observed that the dental crown size, dental crown position, and dental crown angle are almost completely matched, and the feature points of the patient's dental crown model finally generated by the model generation unit 107 almost overlap with the parabolic regression equation 501. Afterwards, by cooperating with the 3D printer 108 to perform 3D printing, temporary braces suitable for the patient can be fabricated in a timely manner. Therefore, the fabrication of the temporary braces can be completed for the patient on the same day.

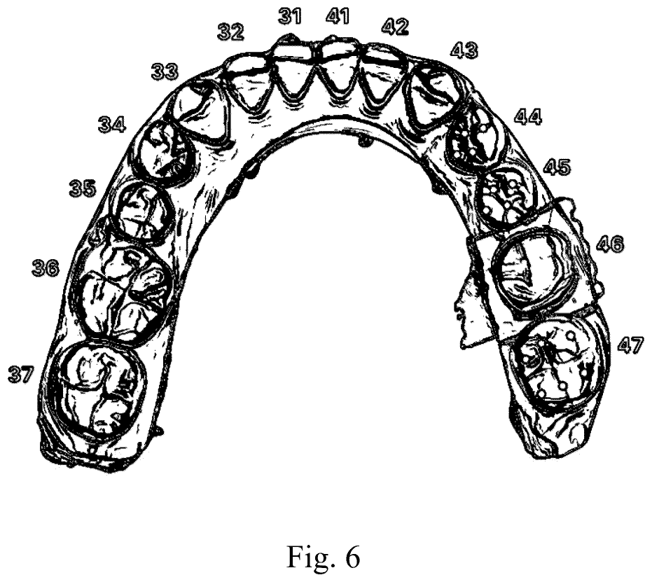

The above embodiment uses an incisor as an example, in which the incisor has only two feature points, and only one parabolic regression equation is calculated for illustration. However, in practical applications, it is not limited to a single condition. In order to enable those ordinarily skilled in the art to understand the present invention, a more complex example is provided below. FIG. 6 shows a schematic diagram of a 3D dental image model scanned by a 3D image input device 101 of the dental crown model generation system according to a preferred embodiment of the present invention. Referring to FIG. 6. in the present embodiment, a molar numbered with 46 is taken as an example. At this time, an image recognition AI model within the geometric feature generation module 102 locates a target position 46 of a tooth to be treated from the 3D dental image model and retrieve data of the preset tooth model of the tooth numbered with 46.

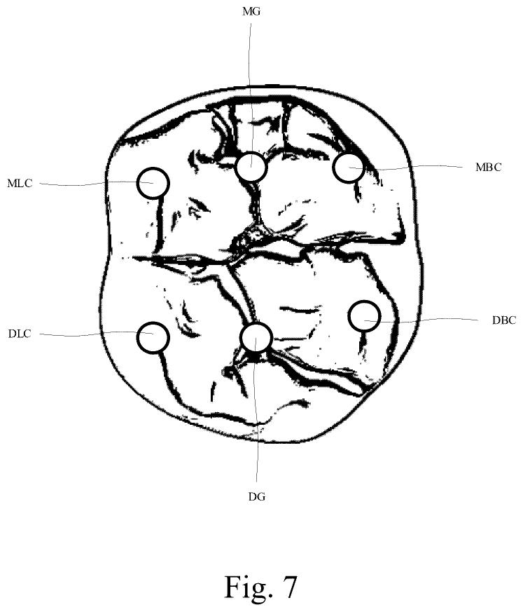

FIG. 7 shows a schematic diagram of a preset tooth model 46 retrieved from the 3D dental image model shown in FIG. 6 by the dental crown model generation system according to a preferred embodiment of the present invention. FIG. 7 illustrates a top view of the preset tooth model 46. The top view of the preset tooth model 46 includes six geometric feature points that are the Mesio-Buccal cusp (MBC) feature point, the Distal-Buccal cusp (DBC) feature point, the Mesio-Lingual cusp (MLC) feature point, the Distal-Lingual cusp (DLC) feature point, the mesial groove (MG) feature point, and the distal groove (DG) feature point. These geometric feature points are used to accurately position each tooth's location and shape in the teeth model, particularly, when creating digital models of teeth, ensuring the tooth shapes align with the patient's occlusal state.

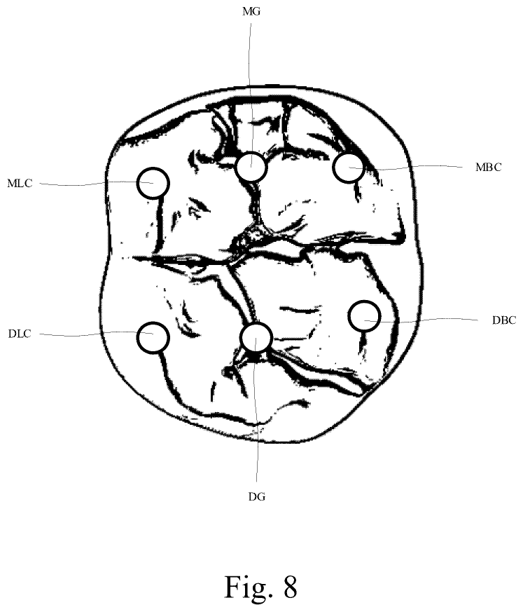

A corresponding plurality of dental model parameters, such as rotation parameters, stretching parameters, translation parameters, etc., in initial preset teeth model data are inputted into the AI denture analysis model 104 to trigger the conditional operation generation module 103 within the AI denture analysis model 104 to begin operation. FIG. 8 shows a schematic diagram of a top-view regression curve calculated by a conditional operation generation module 103 of the dental crown model generation system based on buccal cusp feature points of adjacent teeth according to a preferred embodiment of the present invention. Referring to FIG. 8, in the present embodiment, the geometric feature generation module 102 determines a plurality of geometric features based on the 3D dental image model. Feature coordinates 801 are used as an example, but the actual applications will also include geometric feature parameters such as edge points, edge lines, and crown base coordinates, which will be described later. In the present embodiment, these feature coordinates 801 are automatically identified by the image recognition AI model and are divided into three groups. The first group of feature coordinates 801 represent the buccal cusp feature points and correspond to protruding portions of the tooth cusps near the cheek. There are four buccal cusp feature points shared by the remaining two premolars and the posterior molar. Based on clinical data and experience, the buccal cusp feature points tend to be arranged in a near-parabolic pattern. Therefore, in the present embodiment, the conditional operation generation module 103 performs a regression analysis operation to obtain a parabolic regression equation 802 for the outer edge of a top-down view based on the feature coordinates 801 of FIG. 8, the preset feature points MBC and DBC of the preset tooth model 46 at initial positions, and a tooth shape curve.

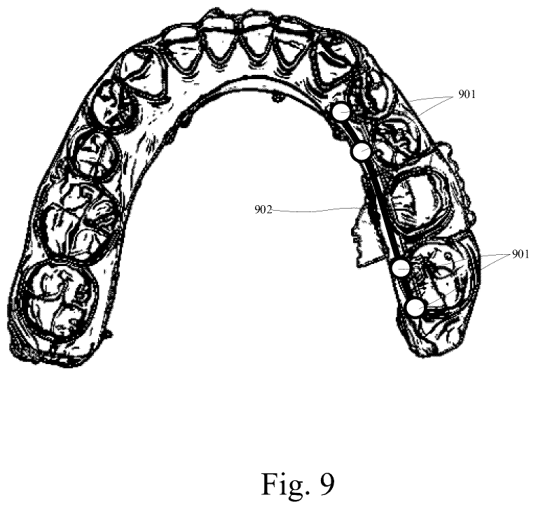

FIG. 9 shows a schematic diagram of a top-view regression curve calculated by a conditional operation generation module 103 of the dental crown model generation system based on lingual cusp feature points of adjacent teeth according to a preferred embodiment of the present invention. Referring to FIG. 9, similarly, the second group of feature coordinates 901 represent the lingual cusp feature points and correspond to protruding portions of the tooth cusps near the tongue. There are four lingual cusp feature points shared by the remaining two premolars and the posterior molar. Based on clinical data and experience, the lingual cusp feature points tend to be arranged in an approximately straight line. Therefore, in the present embodiment, the conditional operation generation module 103 performs a regression analysis operation to obtain a straight-line regression equation 902 for the inner edge of a top-down view based on the feature coordinates 901 of FIG. 9, the preset feature points MLC and DLC of the preset tooth model 46 at initial positions, and a tooth shape curve.

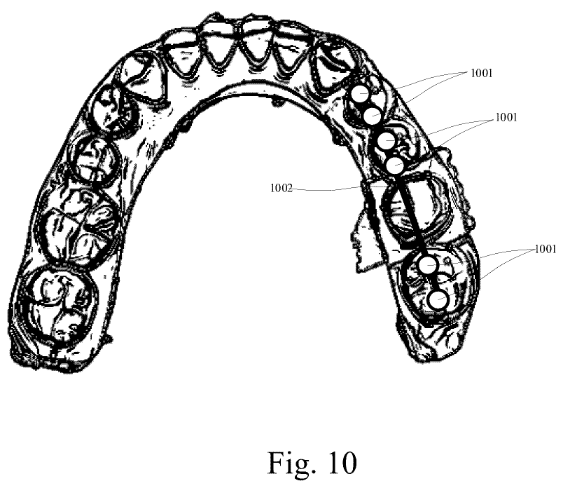

FIG. 10 shows a schematic diagram of a top-view regression curve calculated by a conditional operation generation module 103 of the dental crown model generation system based on groove feature points of adjacent teeth according to a preferred embodiment of the present invention. Referring to FIG. 10, similarly, the third group of feature coordinates 1001 represent the groove feature points and correspond to connecting parts of the grooves near the center of the teeth. There are six groove feature points shared by the remaining two premolars and the posterior molar. Based on clinical data and experience, the groove feature points tend to be arranged in an approximately straight line. Therefore, in the present embodiment, the conditional operation generation module 103 performs a regression analysis operation to obtain a straight-line regression equation 1002 for the inner portion of a top-down view based on the feature coordinates 1001 of FIG. 10, the preset feature points MG and DG of the preset tooth model 46 at initial positions, and a tooth shape curve.

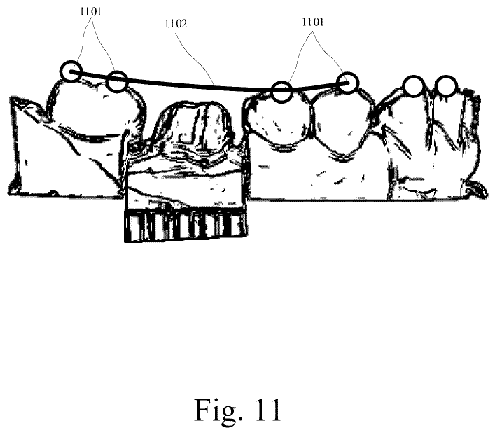

FIG. 11 shows a schematic diagram of an outer side-view regression curve calculated by a conditional operation generation module 103 of the dental crown model generation system based on buccal cusp feature points of adjacent teeth according to a preferred embodiment of the present invention. Referring to FIG. 11, in the present embodiment, the feature coordinates are similarly divided into three groups as in the previous embodiments. In the present embodiment, the feature coordinates 1101 represent the buccal cusp feature points. There are four buccal cusp feature points shared by the remaining two premolars and the posterior molar. Based on clinical data and experience, the buccal cusp feature points on the outer side also tend to be a near-parabolic pattern. Therefore, in the present embodiment, the conditional operation generation module 103 performs a regression analysis operation to obtain a parabolic regression equation 1102 for the upper edge of an outer side-view based on the feature coordinates 1101 of FIG. 11, the preset feature points MBC and DBC of the preset tooth model 46 at initial positions, and a tooth shape curve.

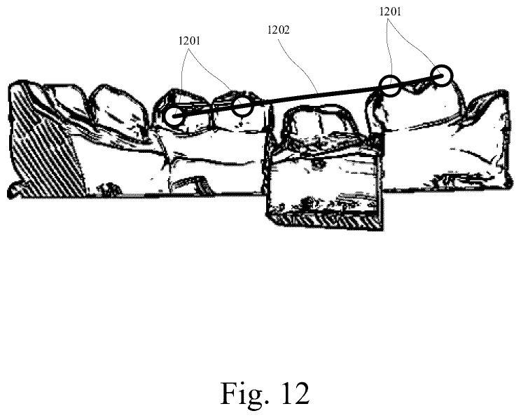

FIG. 12 shows a schematic diagram of an inner side-view regression curve calculated by a conditional operation generation module 103 of the dental crown model generation system based on lingual cusp feature points of adjacent teeth according to a preferred embodiment of the present invention. Referring to FIG. 12, in the present embodiment, the feature coordinates 1201 represent the lingual cusp feature points, which are the second group of feature coordinates. There are four lingual cusp feature points shared by the remaining two premolars and the posterior molar. Based on clinical data and experience, the lingual cusp feature points tend to be arranged in an approximately straight line. Therefore, in the present embodiment, the conditional operation generation module 103 performs a regression analysis operation to obtain a straight-line regression equation 1202 for the upper edge of an inner side-view based on the feature coordinates 1201 of FIG. 12, the preset feature points MLC and DLC of the preset tooth model 46 at initial positions, and a tooth shape curve.

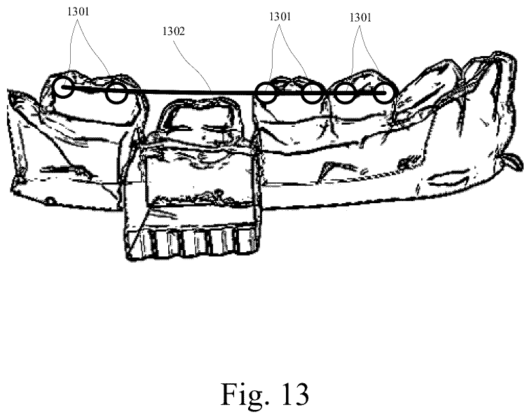

FIG. 13 shows a schematic diagram of an inner side-view regression curve calculated by a conditional operation generation module 103 of the dental crown model generation system based on groove feature points of adjacent teeth according to a preferred embodiment of the present invention. Referring to FIG. 13, in the present embodiment, the feature coordinates 1301 represent the groove feature points, which are the third group of feature coordinates. There are six groove feature points shared by the remaining two premolars and the posterior molar. Based on clinical data and experience, the groove feature points tend to be arranged in an approximately straight line. Therefore, in the present embodiment, the conditional operation generation module 103 performs a regression analysis operation to obtain a straight-line regression equation 1302 for the inner portion of an inner side-view based on the feature coordinates 1301 of FIG. 13, the preset feature points MG and DG of the preset tooth model 46 at initial positions, and a tooth shape curve.

The above embodiments are primarily designed to implement anatomical alignment and axial positioning. The primary function of the anatomical alignment and axial positioning is to control and make the shape of the dental crown to conform to the arrangement rules of natural teeth, including: the facial view for ensuring the alignment of the incisal edge and smoothness of the curve, the occlusal view for ensuring that the positions of the grooves and cusps are reasonable, the lateral view for ensuring that the overall shape of the dental crown meets biomechanical requirements, and axial positioning for ensuring the correct implantation direction of the dental crown without affecting the occlusion of adjacent teeth and abutments. Therefore, a regression operation is used to make the feature points of the preset tooth model 46 as close as possible to a feature curve. However, in addition to the above regression equations, there are many important conditional operations that need to be met for the dental crown. For example, abutment coverage and manufacturing compliance is an important condition. To ensure that the dental crown fully covers the abutment tooth and fits the tooth margin to prevent defects (such as holes or overly thin areas), a tooth is, for example, ground down to make a dental crown, or an abutment is, for example, made for an implant. The goal is to have the tooth model completely enclose the abutment tooth.

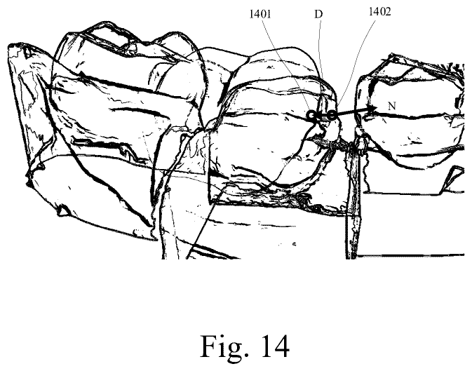

FIG. 14 shows a schematic diagram of a vector dot product calculated by a conditional operation generation module 103 of the dental crown model generation system based on conditions of an abutment tooth according to a preferred embodiment of the present invention. Referring to FIG. 14, in the present embodiment, a point 1402 on the surface of the abutment tooth is used to create the normal vector N, and the point 1402 on the surface of the abutment tooth and a point 1401 closest to the initial position of the preset tooth model 46 are used to create a vector D. The dot product of the two vectors N and D is then calculated. Those ordinarily skilled in the art can see that if the result of the dot product is positive, it indicates that the vector N and the vector D are in the same direction; if the result of the dot product is negative, it indicates that the vector N and the vector D are in opposite directions; the more positive the value of the dot product, the higher the similarity between the vector N and the vector D; and the more negative the value of the dot product, the lower the similarity between the vector N and the vector D. Subsequently, by summing up all the dot products, the abutment coverage and manufacturing compliance score can be obtained. In the case of FIG. 14, since the initial position of the preset tooth model 46 is not configured on the abutment tooth, the coordinates at the initial position of the preset tooth model 46 will inevitably overlap with those of the abutment tooth, resulting in the dot product of the N vector and the D vector of many coordinates being negative. Therefore, it will have a significant negative impact on the abutment coverage and manufacturing compliance score.

Next, proximal contact and occlusal thickness regulation are also crucial conditions. The primarily function of the proximal contact and occlusal thickness regulation is to deal with the relationship between the dental crown and adjacent or opposing teeth and includes controlling the dental crown's contact points to meet clinical standards and avoid excessively large or small contact gaps. In addition, the occlusal thickness of the dental crown meets structural strength requirements, avoiding excessive thinness or compromising the patient's occlusal function.

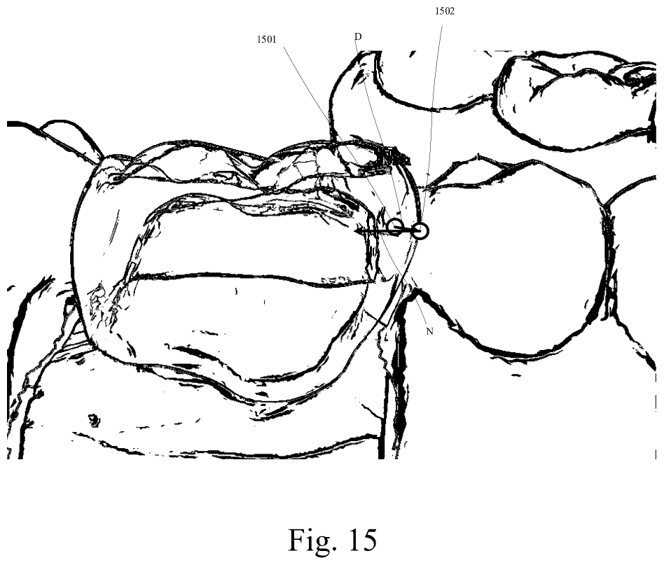

FIG. 15 shows a schematic diagram of a vector dot product calculated by a conditional operation generation module 103 of the dental crown model generation system based on conditions of a dental crown position and adjacent teeth according to a preferred embodiment of the present invention. Referring to FIG. 15, the goal in the present embodiment is to ensure that the dental crown model makes proper contact with the adjacent teeth, avoiding excessive distance that could create gaps between teeth or preventing overlapping with the adjacent teeth that could cause interference. Therefore, the present embodiment utilizes the normal vector N of the point, for example, the coordinate 1502, to which the coordinate 1501 among all points of the adjacent teeth is closest, and calculates the dot product of the difference vector D, which is from the coordinate 1501 to the coordinate 1502, and the normal vector N of the coordinate 1502. Similarly, since the dot product can be considered as the similarity between two vectors that are in opposite directions, the dot product should originally be negative. However, considering the situation of overlapping adjacent teeth, it is important to consider proximity without contact. Therefore, the calculated score should be as great as possible (that is, the less negative, the better). Similarly, by summing up the final dot product results, a score for proximity relationship and occlusal thickness adjustment can be obtained.

Further, the morphological symmetry and shape constraints are also relatively important conditions. The functions of the morphological symmetry and shape constraints include ensuring that the shape of the dental crown resembles that of the contralateral or adjacent teeth, maintaining aesthetics and functionality. The functions of the morphological symmetry and shape constraints also include limiting the deformation range of the dental crown model to meet anatomical, aesthetic, and biomechanical requirements. The functions of the morphological symmetry and shape constraints also include maintaining the bilateral symmetry of the dental crown to align with the patient's dental arch morphology. These functions specifically targets teeth that significantly impact appearance, such as incisors.

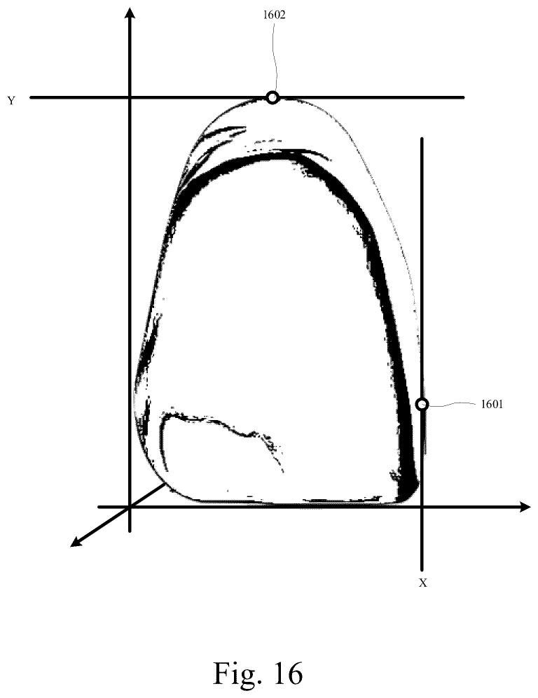

FIG. 16 shows a schematic diagram of an operation condition calculated by a conditional operation generation module 103 of the dental crown model generation system based on conditions of a dental crown model according to a preferred embodiment of the present invention. Referring to FIG. 16, the goal is to limit the width-to-length ratio of the maxillary central incisor crown model to be greater than 70%. Taking FIG. 16 as an example, the coordinate points 1601 and 1602 of the tooth's widest portion (with the maximum X value) and longest portion (with the maximum Y value) are obtained. By applying the X value of the coordinate 1601 and the Y value of the coordinate 1602 to the scoring formula, min (X/Y−0.7), the score for the “morphological symmetry and shape constraints” can be calculated and obtained. In the present embodiment, the greater the score for the morphological symmetry and shape constraints, the better.

After the six regression equations 802, 902, 1002, 1102, 1202, 1302 are determined with other dental model-related conditional operations generated, the AI denture analysis model 104 will score and weight a matching degree between models, which are generated based on the inputted rotation parameters, stretching parameters, translation parameters, and other critical dental parameters, and the conditional operations, such as the generated regression equations 802, 902, 1002, 1102, 1202, and 1302, to obtain a denture score. The denture score is then transmitted to the judgment module 106. The judgment module 106 can compare the denture score with a threshold score. When the denture score is below the threshold score, it outputs the denture score to the parameter correction AI unit 105. The parameter correction AI unit 105 adjusts and updates the plurality of dental model parameters based on the inputted denture score and feed the updated plurality of dental model parameters back to the AI denture analysis model. Through the iterative operation of the AI denture analysis model 104, the judgment module 106, and the parameter correction AI unit 105, the process continues until the denture score exceeds the threshold score. The judgment module 106 then transmits a final plurality of dental model parameters to the model generation unit 107. The model generation unit 107 generates a patient's dental crown model based on a test tooth model corresponding to the plurality of dental model parameters.

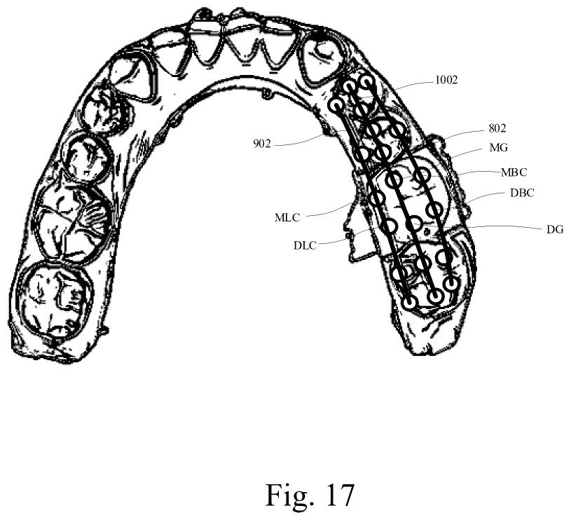

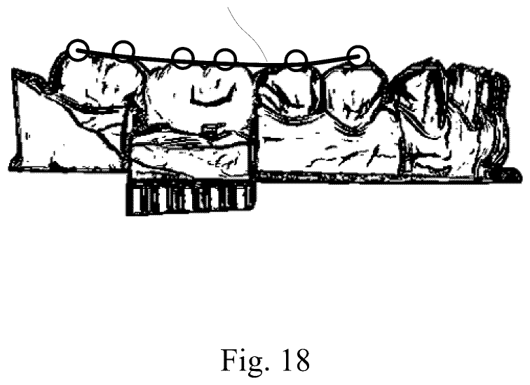

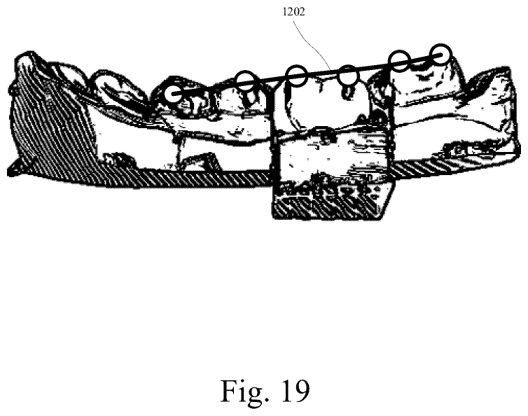

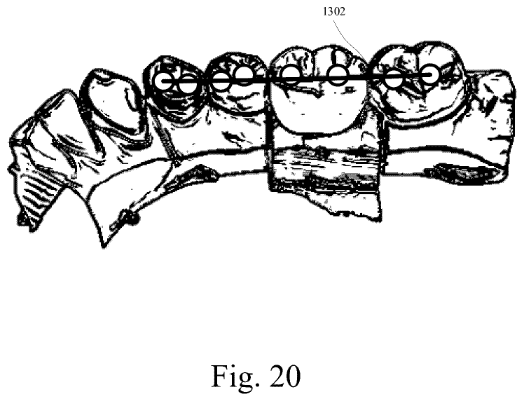

FIG. 17 to FIG. 20 respectively show schematic diagrams of a patient's dental crown model generated by the dental crown model generation system according to a preferred embodiment of the present invention. Referring to FIG. 17, those ordinarily skilled in the art can see that after n cycles of optimizing operations through the AI denture analysis model 104, the judgment module 106, and the parameter correction AI unit 105, the feature points MBC and DBC have become very close to the aforementioned parabolic regression equation 802 for the outer edge of a top-down view. Similarly, the feature points MLC, DLC, as well as the feature points MG and DG have also become very close to the above-mentioned straight line regression equation 902 for the inner edge of a top-down view and straight-line regression equation 1002 for the inner portion of a top-down view, respectively. In addition, from FIG. 18 to FIG. 20, it can also be observed that the feature points of the final generated patient's dental crown model are very close to the corresponding aforementioned parabolic regression equation 1102 for the upper edge of an outer side-view, straight line regression equation 1202 for the upper edge of an inner side-view, and straight line regression equation 1302 for the inner portion of an inner side-view.

In the above embodiments, the regression equations include quadratic parabolas and straight lines. However, in actual system operations, a unified quadratic curve is typically used for regression approximation for convenience in adjustments, and as long as the coefficient of the quadratic term or corresponding term is sufficiently small, it can effectively approximate a straight line. Therefore, the present invention is not limited to use quadratic, linear, or higher-order polynomial approximation methods.

The above embodiments utilize a geometric feature generation module 102 and an internal image recognition AI model for determining feature points. However, those ordinarily skilled in the art should understand that even without the geometric feature generation module 102, dentists can manually annotate feature points on the scanned 3D dental image model. Moreover, if the feature points identified by the image recognition AI model are found to be incorrect during manual inspection, dentists can also perform manual corrections. Therefore, the present invention is not limited thereto. Furthermore, although the above embodiments only describe conditional operations such as feature curve operations, dot product operations, and appearance ratio operations, those ordinarily skilled in the art should understand that in the field of dentistry and dental crowns, there are many other conditions that can optimize the dental crown model of the present invention. Even if these conditions are not disclosed in the above embodiments, in practice, these undisclosed conditional operations can be selectively included or excluded from the image recognition AI model based on different circumstances. Therefore, the present invention is not limited to the above embodiments.

In addition, although the above embodiments involve considering the geometric feature coordinates of the patient's dental crown model in the regression operation to generate a regression curve, those ordinarily skilled in the art should understand that it is still possible to selectively exclude the geometric feature coordinates of the dental crown model and rely solely on the feature coordinates of the remaining teeth to generate the regression curve. However, when considering the need to fabricate dental crowns for two or more teeth, using the geometric feature coordinates of two dental crown models simultaneously will fabricate a dental mold that better fits the patient. Thus, the above case is only a demonstration of a preferable example. In actual practice, different situations may occur. For example, when there are many remaining teeth and only one tooth requires treatment, the regression operation can be performed using only the geometric feature coordinates of the remaining teeth while ignoring the preset geometric feature coordinates of the inputted dental crown model. Therefore, the present invention is not limited thereto.

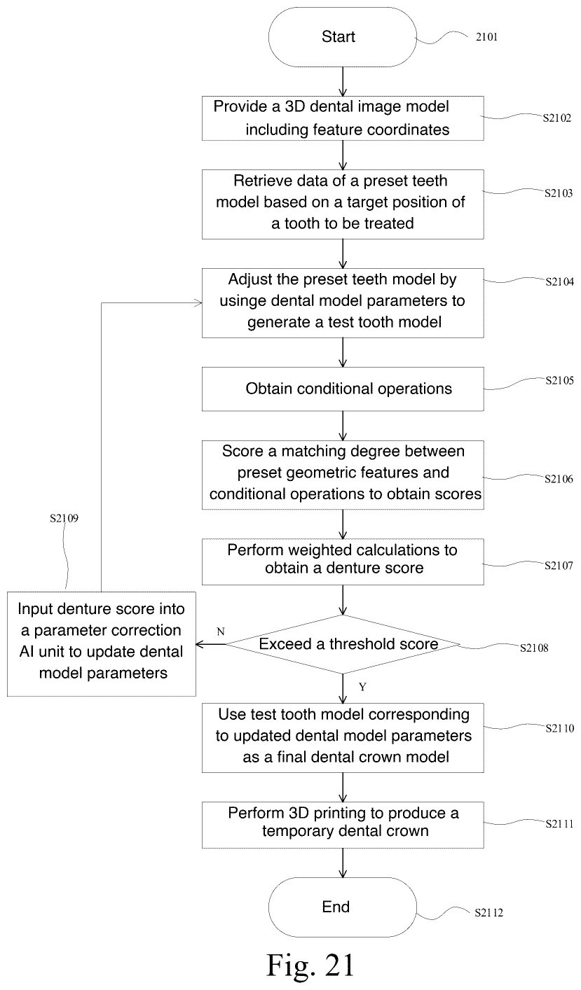

The above embodiments can be summarized into a dental crown model generation method. FIG. 21 shows a flowchart of a dental crown model generation method according to a preferred embodiment of the present invention. Referring to FIG. 21, the dental crown model generation method include the following steps.

### Step S2101: Start.

Step S2102: Provide a three-dimensional (3D) dental image model including a plurality of feature coordinates. As described in the above embodiments, after the patient undergoes a three-dimensional dental image model scan, a three-dimensional dental image model is obtained. Meanwhile, a target position of a tooth to be treated is identified through, for example, an image recognition AI unit, and a plurality of feature coordinates are provided based on the morphology of the surrounding teeth (e.g., incisors, canines, premolars, and molars).

Step S2103: Retrieve data of a preset teeth model based on a target position of a tooth to be treated. For example, the preset teeth model corresponding to the position of the tooth to be treated is retrieve from built-in teeth models through an image recognition AI unit.

Step S2104: Adjust the preset teeth model by using a plurality of dental model parameters to generate a test tooth model, thereby obtaining a plurality of preset geometric features. In the above-mentioned embodiments related to regression operations, if the tooth to be treated is an incisor, there will be two feature points; and if it is a molar, there will be six feature points. In addition, the retrieved geometric features may vary depending on different conditional operations applied, for example, the closest points adopted in the dot product operation mentioned above. Therefore, the present invention is not limited to the above embodiments.

Step S2105: Obtain a plurality of conditional operations based on a tooth shape curve and the plurality of geometric features. As described in the above embodiments, the operations of the regression equations generally includes operations on the inner side-view, outer side-surface, and top view. The number of regression equations may vary depending on the complexity of the treated tooth. For example, there may be two to three regression equations for incisors while there may be up to six regression equations for molars. Furthermore, the vector dot product and the dental crown position calculated based on abutment tooth conditions and the vector dot product and the width-to-length ratio of the incisor crown model calculated based on adjacent teeth conditions all belong to conditional operations.

Step S2106: Score a matching degree between the plurality of preset geometric features and the plurality of conditional operations to obtain a plurality of scores. In the above embodiments, the matching degree is scored through an AI denture analysis model.

Step S2107: Perform weighted calculations on the plurality of scores using a plurality of weights to obtain a denture score. In the above embodiments, the scores are weighted through the AI denture analysis model.

Step S2108: Determine whether the denture score exceeds a threshold score. If the denture score is below the threshold score, proceed to Step S2109. If the denture score exceeds the threshold score, proceed to Step S2110.

Step S2109: Input the denture score into a parameter correction artificial intelligence unit to update the plurality of dental model parameters. Then, return to Step S2104 to repeat the steps until Step S2108 determines that the denture score exceeds the threshold score. Generally, the weighted calculations are assigned different weights based on the importance dentists or dental technicians place on these conditional operations. For example, if there is a mismatch with the abutment tooth, even if the score of the regression operation related to occlusion is high, the final weighted score will be significantly lowered due to the abutment tooth mismatch, as the dental crown cannot be installed. Accordingly, after several cycles of repeating steps, the parameter correction AI unit can identify which dental model parameters significantly improve the score and which dental model parameters have minimal impact. Thus, the score gradually converges during these cycles of repeating steps.

Step S2110: Use the test tooth model corresponding to the updated plurality of dental model parameters as a final dental crown model. This final dental crown model serves as the patient's dental crown model.

Step S2111: Perform three-dimensional (3D) printing according to the final dental crown model to produce a temporary dental crown. As a result, the fabrication of the temporary braces can be completed for the patient on the same day, further improving treatment efficiency. However, this step can be modified or omitted depending on circumstances. For example, if there is a collaborating manufacturer, this final dental crown model can also be provided to the manufacturer to customize the dental crown. If a milling machine is available, immediate customization can be performed to directly produce a permanent dental crown after the patient selects the material. Therefore, the present invention is not limited thereto.

### Step S2112: End.

In summary, the preferred embodiments of the present invention propose a dental crown model generation method based on a 3D imaging model, offering significant advantages over prior art. First, traditional methods require dentists to manually create dental crown models and rely on individual adjustments for temporary dental crowns, which is cumbersome and time-consuming. In contrast, the preferred embodiments of the present invention utilize regression analysis and AI automatic parameter adjustments, significantly reducing production time while minimizing human errors and instability. Secondly, the preferred embodiments of the present invention perform precise calculations and automatic optimization based on the patient's 3D imaging data and tooth shape curves, thereby eliminating the need for manual carving or multiple adjustments. This ensures the accuracy of the crown model and meets the individual needs of the patient. Compared to the tedious process in traditional methods, in which dentists repeatedly adjust the model, the present invention significantly reduces the burden on dentists and the potential for errors. Finally, since the generated patient's dental crown model can be directly printed using a 3D printer, patients can have their temporary dental crowns fabricated on the same day, further improving treatment efficiency. Moreover, if a milling machine is available, a permanent dental crown can also be directly produced, eliminating the lengthy waiting times and multiple adjustments required in traditional methods, thereby significantly enhancing patient comfort and treatment experience. Therefore, the preferred embodiments of the present invention provide a more efficient and precise dental treatment solution.

The specific embodiments presented in the detailed description of the preferred embodiments are merely intended to facilitate the illustration of the technical content of the present invention and should not be construed as narrowly limiting the invention to the above embodiment. Any modifications made without departing from the spirit of the present invention and the appended claims shall fall within the scope of the present invention. Accordingly, the protection scope of the present invention shall be determined by the appended claims.

What is claimed is:

1. A dental crown model generation method, comprising:
providing a three-dimensional dental image model including a plurality of geometric features;
retrieving data of a preset teeth model based on a target position of a tooth to be treated;
step A: adjusting the preset teeth model by using a plurality of dental model parameters to generate a test tooth model, thereby obtaining a plurality of preset geometric features;
step B: generating a plurality of conditional operations based on the plurality of geometric features;
step C: scoring a matching degree between the plurality of preset geometric features and the plurality of conditional operations to obtain a plurality of scores;
step D: performing weighted calculations on the plurality of scores using a plurality of weights to obtain a denture score;
if the denture score being below a threshold score, inputting the denture score into a parameter correction artificial intelligence unit to update the plurality of dental model parameters and repeating step A to step D until the denture score exceeds the threshold score; and
using the test tooth model corresponding to the updated plurality of dental model parameters as a final dental crown model.

2. The dental crown model generation method of claim 1, wherein providing the three-dimensional dental image model further comprising:
inputting the three-dimensional dental image model;
locating, by an image recognition artificial intelligence unit, the target position of the tooth to be treated from the three-dimensional dental image model; and
determining, by the image recognition artificial intelligence unit, a plurality of feature coordinates based on at least one adjacent residual tooth adjacent to the target position.

3. The dental crown model generation method of claim 1, wherein providing the three-dimensional dental image model further comprising:
setting a plurality of protruding portions as a plurality of outer edge feature coordinates in the three-dimensional dental image model;
wherein generating the plurality of conditional operations further comprises:
performing a regression analysis operation for the plurality of outer edge feature coordinates to obtain a parabolic regression equation for an outer edge of a top-down view.

4. The dental crown model generation method of claim 1, wherein providing the three-dimensional dental image model further comprising:
setting a plurality of protruding portions as a plurality of inner edge feature coordinates in the three-dimensional dental image model;
wherein generating the plurality of conditional operations further comprises:
performing a regression analysis operation for the plurality of inner edge feature coordinates to obtain a straight-line regression equation for an inner edge of a top-down view.

5. The dental crown model generation method of claim 1, wherein providing the three-dimensional dental image model further comprising:
setting a plurality of groove portions as a plurality of inner portion feature coordinates in the three-dimensional dental image model;
wherein generating the plurality of conditional operations further comprises:
performing a regression analysis operation for the plurality of inner portion feature coordinates to obtain a straight-line regression equation for an inner portion of a top-down view.

6. The dental crown model generation method of claim 1, wherein providing the three-dimensional dental image model further comprising:
setting a plurality of protruding portions as a plurality of upper edge feature coordinates in the three-dimensional dental image model;
wherein generating the plurality of conditional operations further comprises:
performing a regression analysis operation for the plurality of upper edge feature coordinates to obtain a parabolic regression equation for an upper edge of an outer side-view.

7. The dental crown model generation method of claim 1, wherein providing the three-dimensional dental image model further comprising:
setting a plurality of protruding portions as a plurality of upper edge feature coordinates in the three-dimensional dental image model;
wherein generating the plurality of conditional operations further comprises:
performing a regression analysis operation for the plurality of upper edge feature coordinates to obtain a straight-line regression equation for an upper edge of an inner side-view.

8. The dental crown model generation method of claim 1, wherein providing the three-dimensional dental image model further comprising:
setting a plurality of groove portions as a plurality of inner portion feature coordinates in the three-dimensional dental image model;
wherein generating the plurality of conditional operations further comprises:
performing a regression analysis operation for the plurality of inner portion feature coordinates to obtain a straight-line regression equation for an inner portion of an inner side-view.

9. The dental crown model generation method of claim 1, wherein using the test teeth model corresponding to the updated plurality of dental model parameters as the final dental crown model further comprising:
performing three-dimensional printing to produce a temporary dental crown based on the final dental crown model.

10. The dental crown model generation method of claim 1, wherein the plurality of dental model parameters at least include:
a rotation parameter for determining an angle of the test tooth model relative to a fixed point;
a stretching parameter for determining a stretching length of at least one axis of the test tooth model; and
a translation parameter for determining a position of the test tooth model relative to the fixed point.

11. The dental crown model generation method of claim 1, wherein providing the three-dimensional dental image model further comprising:
setting a plurality of feature coordinates at a plurality of positions of an abutment tooth in the three-dimensional dental image model;
wherein generating the plurality of conditional operations further comprises:
performing a plurality of dot product operations respectively between normal vectors of the plurality of feature coordinates and vectors of closest points corresponding to the test tooth model.

12. The dental crown model generation method of claim 11, wherein scoring the matching degree further comprises:
summing results of the plurality of dot product operations to obtain a score for abutment coverage and manufacturing compliance.

13. The dental crown model generation method of claim 1, wherein providing the three-dimensional dental image model further comprising:
setting a plurality of feature coordinates at edge positions of teeth adjacent to an abutment tooth in the three-dimensional dental image model;
wherein generating the plurality of conditional operations further comprises:
performing a plurality of dot product operations between normal vectors of the plurality of feature coordinates and vectors of closest points corresponding to the test tooth model.

14. The dental crown model generation method of claim 13, wherein scoring the matching degree further comprises:
summing results of the plurality of dot product operations to obtain a score for proximity relationship and occlusal thickness adjustment.

15. The dental crown model generation method of claim 1, wherein generating the plurality of conditional operations further comprises:
performing a calculation on a width-to-length ratio of the test tooth model.

16. The dental crown model generation method of claim 15, wherein scoring the matching degree further comprises:
subtracting a proportional constant from the width-to-length ratio of the test tooth model to obtain a score for morphological symmetry and shape constraints.

17. A dental crown model generation system, comprising:
a three-dimensional image input device configured to scan teeth to obtain a three-dimensional dental image model, retrieve data of a preset teeth model based on a target position of the three-dimensional dental image model, and provide a plurality of geometric features according to the three-dimensional dental image model;
an artificial intelligence denture analysis model configured to perform:
step A: adjusting the preset teeth model by using a plurality of dental model parameters to generate a test tooth model, thereby obtaining a plurality of preset geometric features;
step B: generating a plurality of conditional operations based on the plurality of geometric features;
step C: scoring a matching degree between the plurality of preset geometric features and the plurality of conditional operations to obtain a plurality of scores;
step D: performing weighted calculations on the plurality of scores using a plurality of weights to obtain a denture score;
a parameter correction artificial intelligence unit configured to update the plurality of dental model parameters based on the denture score and feed the updated plurality of dental model parameters back to the artificial intelligence denture analysis model;
a judgment module configured to compare the denture score with a threshold score, wherein when the denture score is below the threshold score, the judgment module outputs the denture score to the parameter correction artificial intelligence unit; and
a model generation unit coupled to the judgment module, wherein when the denture score exceeds the threshold score, the model generation unit generates a final dental crown model based on the test tooth model corresponding to the updated plurality of dental parameters.

18. The dental crown model generation system of claim 17, wherein the three-dimensional image input device further includes:
a geometric feature generation module including an image recognition artificial intelligence model configured to locate the target position of the tooth to be treated from the three-dimensional dental image model and determine a plurality of feature coordinates based on at least one residual tooth adjacent to the target position.

19. The dental crown model generation system of claim 17, wherein:
when the image recognition artificial intelligence model sets a plurality of protruding portions as a plurality of outer edge feature coordinates in the three-dimensional dental image model, a conditional operation generation module is configured to perform a regression analysis operation for the plurality of outer edge feature coordinates to obtain a parabolic regression equation for an outer edge of a top-down view.

20. The dental crown model generation system of claim 17, wherein:
when the image recognition artificial intelligence model sets a plurality of protruding portions as a plurality of inner edge feature coordinates in the three-dimensional dental image model, a conditional operation generation module is configured to perform a regression analysis operation for the plurality of inner edge feature coordinates to obtain a straight-line regression equation for an inner edge of a top-down view.

21. The dental crown model generation system of claim 17, wherein:
when the image recognition artificial intelligence model sets a plurality of groove portions as a plurality of inner portion feature coordinates in the three-dimensional dental image model, a conditional operation generation module is configured to perform a regression analysis operation for the plurality of inner portion feature coordinates to obtain a straight-line regression equation for an inner portion of a top-down view.

22. The dental crown model generation system of claim 17, wherein:
when the image recognition artificial intelligence model sets a plurality of protruding portions as a plurality of upper edge feature coordinates in the three-dimensional dental image model, a conditional operation generation module is configured to perform a regression analysis operation for the plurality of upper edge feature coordinates to obtain a parabolic regression equation for an upper edge of an outer side-view.

23. The dental crown model generation system of claim 17, wherein:
when the image recognition artificial intelligence model sets a plurality of protruding portions as a plurality of upper edge feature coordinates in the three-dimensional dental image model, a conditional operation generation module is configured to perform a regression analysis operation for the plurality of upper edge feature coordinates to obtain a straight-line regression equation for an upper edge of an inner side-view.

24. The dental crown model generation system of claim 17, wherein:
when the image recognition artificial intelligence model sets a plurality of groove portions as a plurality of inner portion feature coordinates in the three-dimensional dental image model, a conditional operation generation module is configured to perform a regression analysis operation for the plurality of inner portion feature coordinates to obtain straight line regression equation for an inner portion of an inner side-view.

25. The dental crown model generation system of claim 17, further comprising:
a three-dimensional printer coupled to the model generation unit and configured to produce a temporary dental crown based on the final dental crown model.

26. The dental crown model generation system of claim 17, wherein the plurality of dental model parameters at least include:
a rotation parameter for determining an angle of the test tooth model relative to a fixed point;
a stretching parameter for determining a stretching length of at least one axis of the test tooth model; and
a translation parameter for determining a position of the test tooth model relative to the fixed point.

27. The dental crown model generation system of claim 17, wherein the image recognition artificial intelligence model sets a plurality of feature coordinates at a plurality of positions of an abutment tooth in the three-dimensional dental image model,
wherein a conditional operation generation module is configured to generate a plurality of conditional operations and further configured to:
perform a plurality of dot product operations respectively between normal vectors of the plurality of feature coordinates and vectors of closest points corresponding to the test tooth model.

28. The dental crown model generation system of claim 27, wherein the step C performed by the artificial intelligence denture analysis model further comprises:
summing results of the plurality of dot product operations to obtain a score for abutment coverage and manufacturing compliance.

29. The dental crown model generation system of claim 17, wherein the image recognition artificial intelligence model sets a plurality of feature coordinates at edge positions of teeth adjacent to an abutment tooth in the three-dimensional dental image model,
wherein a conditional operation generation module is configured to generate a plurality of conditional operations and further configured to:
performing a plurality of dot product operations respectively between normal vectors of the plurality of feature coordinates and vectors of closest points corresponding to the test tooth model.

30. The dental crown model generation system of claim 29, wherein the step C performed by the artificial intelligence denture analysis model further comprises:
summing results of the plurality of dot product operations to obtain a score for proximity relationship and occlusal thickness adjustment.

31. The dental crown model generation system of claim 17, wherein a conditional operation generation module is configured to generate a plurality of conditional operations and further configured to:
perform a calculation on a width-to-length ratio of the test tooth model.

32. The dental crown model generation system of claim 31, wherein the step C performed by the artificial intelligence denture analysis model further comprises:
subtracting a proportional constant from the width-to-length ratio of the test tooth model to obtain a score for morphological symmetry and shape constraints.
